(19) United States
(12) Patent Application Publication
(10) Pub. No.: US 2021/0406074 A1
(43) Pub. Date: Dec. 30, 2021

(54) DYNAMIC PRODUCT RESOURCE MAPPING OF CLOUD RESOURCES

(71) Applicant: CITRIX SYSTEMS, INC., Burlington, MA (US)

(72) Inventors: Steven Keller, Coral Springs, FL (US); Sindy Giraldo, Deerfield Beach, FL (US); Harshavardhan Pallapothu, Burlington, MA (US); Mansi Shamsingh Raghuwanshi, Burlington, MA (US)

(21) Appl. No.: 16/915,184

(22) Filed: Jun. 29, 2020

(51) Int. Cl. G06F 9/50; G06F 9/455

(52) U.S. Cl. CPC G06F 9/5011; G06F 2009/45583; G06F 9/45558

(57) ABSTRACT

Data characterizing a first address of a software service executing based on a first virtual resource that is within a remote computing environment is received. The executing includes transmitting a request for utilization of the first virtual resource. The received data further characterizes a log of the request for the first virtual resource. The log includes the first address and a second address of the first virtual resource. A mapping between the first address of the software service and the second address of the first virtual resource is determined using the received data. The mapping between the first address of the software service and the second address of the first virtual resource is provided. Related apparatus, systems, techniques and articles are also described.

### TECHNICAL FIELD

The subject matter described herein relates to monitoring and managing the use of cloud resources.

### BACKGROUND

Cloud computing can include the on-demand availability of computer system resources, especially data storage and computing power, without direct active management by the user. The term can be generally used to describe data centers available to many users over the Internet. Large clouds often have functions distributed over multiple locations from central servers.

Some cloud computing providers can allow for scalability and elasticity via dynamic (e.g., “on-demand”) provisioning of resources on a fine-grained, self-service basis. This can provide cloud computing users the ability to scale up when the usage need increases or down if resources are not being used.

### SUMMARY

In an aspect, data characterizing a first address of a software service executing based on a first virtual resource that is within a remote computing environment is received. The executing includes transmitting a request for utilization of the first virtual resource. The received data further characterizes a log of the request for the first virtual resource. The log includes the first address and a second address of the first virtual resource. A mapping between the first address of the software service and the second address of the first virtual resource is determined using the received data. The mapping between the first address of the software service and the second address of the first virtual resource is provided.

One or more of the following features can be included in any feasible way. For example, virtual resources utilized by the software service that are within the remote computing environment can be identified based on the mapping between the first address of the software service and the second address of the first virtual resource. All virtual resources utilized by the software service that are within the remote computing environment can be identified. The mapping between the first address of the software service and the second address of the first virtual resource can include a data object containing a name of the software service, the first address, and data characterizing each virtual resource utilized by the software service.

The receiving can include receiving a plurality of addresses associated with respective software services and receiving a plurality of logs including a plurality of second addresses associated with respective virtual resources. The mapping can be between the plurality of software services and the plurality of virtual resources. The data characterizing the first address of the software service can be received from a resource management inventory system including a database storing software service names and addresses. The data characterizing the log can be received from a repository associated with the software service and logging system transactions between the software service and the virtual resource. The receiving, the determining, and the providing can be repeated based on a new log. The virtual resource can include a virtual machine, a storage account, a web application, a database, and/or a virtual network. The mapping can be provided to a resource management inventory system including a database storing software service names and addresses. The software service can include at least one microservice including executable code deployed in the remote computing environment.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a process flow diagram illustrating an example process for dynamic product resource mapping according to some example implementations;

FIG. 1B illustrates an example data flow diagram illustrating the data flow between system components during the process illustrated in FIG. 1A;

FIG. 2 shows a high-level architecture of an illustrative virtualization system for dynamic product resource mapping;

FIG. 3A depicts a network diagram illustrating an example of a network environment that can enable dynamic product resource mapping;

FIG. 3B depicts a block diagram illustrating an example of a computing device;

FIG. 4 is a process flow diagram illustrating another example process that can enable dynamic product resource mapping; and

FIG. 5 is another process flow diagram illustrating an example process according to some implementations.

Like reference symbols in the various drawings indicate like elements.

### DETAILED DESCRIPTION

Cloud providers can provide a remote computing environment, for example, with virtual machine (VM) infrastructure such as a hypervisor using native execution to share and manage hardware, allowing for multiple environments which are isolated from one another, yet exist on the same physical machine. The computing environment can include an infrastructure as a service (IaaS) platform that provides application programming interfaces (APIs) to dereference low-level details of underlying network infrastructure. In such an IaaS platform, pools of hypervisors can support large numbers of VMs and include the ability to scale up and down services to meet varying needs. IaaS platforms can provide the capability to the user to provision processing, storage, networks, and other fundamental computing resources where the user is able to deploy and run arbitrary software, which can include operating systems and applications. The user may not manage or control the underlying cloud infrastructure but has control over operating systems, storage, and deployed applications; and possibly limited control of select networking components (e.g., host firewalls).

Companies with multiple software product offerings may utilize cloud computing resources for supporting those products. For example, a company may have many products being used by many business customers and millions of end users. Each product can include multiple services and each service can consume some amount of cloud resources as it executes (e.g., operates).

But when utilizing cloud computing to support multiple products, it may not be clear which computing resources are associated with or support each product because the products are supported by the same cloud service provider. While it may be possible to manually track and label each resource with its associated product, such a manual approach requires specific knowledge of the cloud computing environment and may be inappropriate for dynamic resource management. And lacking knowledge of which resources support which products can lead to challenges in implementing security policies, identifying security flaws, tracking product usage for compliance purposes, and the like.

Accordingly, some implementations of the current subject matter include dynamically grouping cloud resources according to product or service using a cloud resource inventory system and transaction logs that capture source and destination internet protocol (IP) addresses. The logs can also include product and/or service information, such as a service name. By associating products and services with the resources used to support those products and services using a log containing IP addresses, some implementations of the current subject matter can automatically associate products and/or services with resources. Moreover, some implementations of the current subject matter can be performed regularly (e.g., daily, weekly, and the like) to capture changes in resource utilization, which can occur, for example, when a change is made to the product or service. And having a mapping of products and services to resources can enable improved security (e.g., policies can be applied at resource level, vulnerability can be easier to identify, and the like), and management of those resources and products, which can improve efficiencies.

In some implementations, cloud resources can be tracked per service and services can be tracked by product. Products can be considered to include multiple services, for example, an aggregation of services to create an experience for a customers. A product can respond to an order for a customer and can provision a set of services, if applicable. Example products can include virtual applications and virtual desktops. A product can have a one to one relationship with a stock-keeping unit (SKU), thus reflecting an available product for purchase by customers.

A service can be considered as a set of microservices that manifests as a feature or product. A set of one or more services can make a product. An example service can include a StoreFront Configuration. In some implementations, multiple products may utilize at least some of the same services (e.g., a service may belong to multiple products). A service or feature can also be provided separately (e.g., as an “add-on” to a product).

A microservice can be considered as a set of code deployed to the cloud with the scoping of specific jobs to functions to service a specific purpose. Example microservices include a “StoreFront Configuration—WebRole” and a “StoreFront Configuration—WorkerRole”. In some implementations, multiple services and products may utilize at least some of the same microservices (e.g., a microservices may belong to multiple services and multiple products).

As described herein, a resource (also referred to as a virtual resource) can include any manageable item that is available through a cloud provider such as virtual machines, storage accounts, web applications, databases, and virtual networks. Other resource types are possible.

Some implementations of the current subject matter can be implemented where there is a logging layer that logs system transactions. For example, all products can require service registration and all system transactions can be logged. The logs can include service addresses (e.g., Internet Protocol (IP) addresses) and cloud resource addresses identifying the cloud resources involved in the system transaction. For example, a system can require that all services register a service key in order to consume (e.g., utilize) services within the system. This information can be leveraged in the logging to identify the IP address of the service making the call. In addition, the log can also include the resource IP address that is being called by the service. In some implementations, services can utilize virtual resources via application programming interface (API) calls and a log can be created related to each API call. The following is an example log message.

TABLE 1
EventTime = 2020-02-27T12:23:48
Level = INFO
LoggingType = Performance
DeploymentId = 954ac784204a4a068c07d32c97372d53
RoleId = AgentHub_IN_1
ServiceName = CitrixService
Version = 7.1.2.33125
LayerName = StagingA
RegionName = EastUS
BuildCommit = 9026e2449033e86f669bd8ff92700368bcaa3341
BuildNumber = 34622
CorrelationId = b9fd8c44-f0a4-46b4-830a-45a51691193c
CustomerId = g8a4thnldlnb
TransactionId = 210676e6-2304-4461-a38b-9707aac0f1aa
RequestMethod = GET
AbsoluteUri = https://agenthub-eastus-release-
a.ctxwsstgapi.net/g8a4thnldlnb/EdgeServers/3e4d2106-7fcb-482b-846e-0da3f2ea2e99
RefererHeader=
UserAgent=
CallerServiceName = EdgeService
CallerServiceInstanceId = 3e4d2106-7fcb-482b-846e-0da3f2ea2e99
SourceIP = ::ffff:207.47.50.254
EventId = ApiPerformance
DestinationIP = ::rrse:765.23.30.678
SourceCode = ApiPerformance.OnActionExecutedAsync@79
Message = {“Service”:“AgentHub”,“Controller”:“EdgeServers”,“Endpoint”:“Get”,“Uri”:
“https://agenthub-eastus-release-
a.ctxwsstgapi.net/g8a4thnldlnb/EdgeServers/3e4d2106-7fcb-482b-846e-
0da3f2ea2e99”,“CanaryRequestedUri”:“https://agenthub-
us.ctxwsstgapi.net/g8a4thnldlnb/EdgeServers/3e4d2106-7fcb-482b-846e-
0da3f2ea2e99”,“IsGlobalRequest”:false,“IsGloballyAware”:false,“Method”:“Get”,“St
artDateTime”:“2020-02-25T21:23:47.9654297Z”,“EndDateTime”:“2020-02-
25T21:23:48.1023632Z”,“Duration”:136.9752,“StatusCode”:“OK”,“Error”:null}

From the log entry shown above, the Source IP address can be used to determine the product/service from where the request originated. The Destination IP address can be used to determine the resources that the service is calling.

In some implementations, the CallerServiceName field can be used to determine the name associated with the key used to access the service. This is can be how the caller is registered within the system. The AbsoluteUri field can be used to determine the specific function being accessed within the service, which can be used to narrow the focus area within the service. The TransactionId field can be used to group together multiple requests that belong to one higher level request. For example, accessing data on a customer premise may require requests to Authenticate, Authorize, Send a Message, Check feature enablement, and the like.

The Customerld field can be used to determine resources that a particular customer is calling (e.g., APIs can be run on behalf of a customer based on an authentication service). The RegionName field can be used to determine resources being called in a particular region. This can be useful, for example, for a state of emergency, (e.g. hurricane, fire, tsunami, and the like) or to ensure adequate resources available from the cloud resource provider because the cloud provider may only have so many resources in a given region. The Message field can be used to determine the time and duration of the specific call. The Message field can be related to overall resource consumption and can be correlated with any system issues (e.g. provider outages, security incidents, and the like)

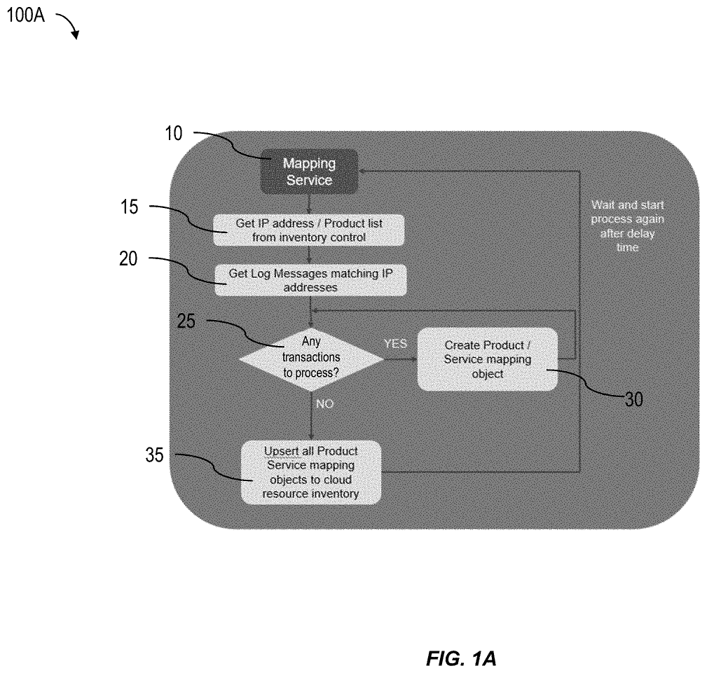

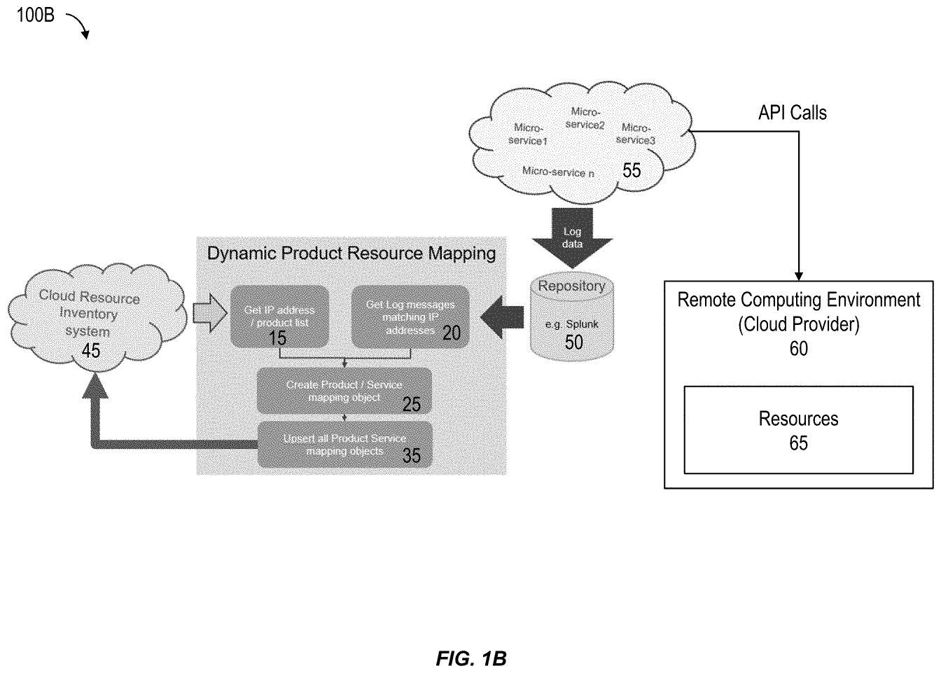

FIG. 1A is a process flow diagram illustrating an example process 100A for dynamic product resource mapping that can include dynamically grouping cloud resources according to product or service using a cloud resource inventory system and transaction logs that capture source and destination internet protocol (IP) addresses. FIG. 1B illustrates an example data flow diagram illustrating the data flow 100B between system components during the process 100A illustrated in FIG. 1A.

With reference to both FIG. 1A and FIG. 1B, at 10, the mapping service can begin. The mapping service can be executed regularly, for example, periodically, such as every hour, day week, and/or month. In some implementations, the mapping service can be used whenever a change to a product or service is deployed, as any changes to a product or service can result in a change to the resource utilization of that product or service.

At 15, a list of products and/or their IP addresses are retrieved from a cloud resource inventory system 45 (e.g., an inventory control). In some implementations, the cloud resource inventory system 45 can include a repository (e.g., database) that includes a list of all products, the services that make up the product, and each services' address, such as IP address. Such a repository can be maintained, for example, by the developers of the products and/or services. In some implementations, the cloud resource inventory system 45 can be automatically maintained, which can include the cloud resource inventory system 45 automatically querying the cloud provider 60 to obtain a list of inventory of cloud resources (e.g., assets) that are currently in use.

At 20, log messages or records of system transactions can be retrieved. The log messages can be retrieved, for example, from a logging repository 50 (illustrated in FIG. 1B) that logs all transactions of a system. System transactions can refer to any utilization of a virtual resource by a product or service (illustrated in FIG. 1B as micro services 55 making API calls to a remote computing environment 60 that includes virtual resources 65). In some implementation, the repository 50 can include Splunk, although other implementations are possible. An example log is described above.

At 25, it is determined whether there are any transactions to process. This can include determining whether there are any additional product or service to resource mappings that have not yet been processed. For example, there may be products and/or logs that have not yet been analyzed. If there are more transactions to process, then at 30, a product or service mapping object can be created and the process 100A can return to step 25. A product or service mapping object can include a data object that characterizes the mapping between a product or service and a resource. For example, the mapping object can characterize the IP address and name of a service as well as the IP addresses of virtual resources that the service has utilized.

If there are no more transactions to process, then at 35, all product or service mapping objects can be added to the cloud resource inventory 45. In some implementations, the cloud resource inventory 45 can include a database including a table and adding the product or service mapping objects can be performed by upserting the objects into the table (e.g., using a merge operation). As noted above, the process 100A can then repeat by returning to step 10.

The mapping between product or service and cloud resources can enable improved security (e.g., policies can be applied at resource level, vulnerability can be easier to identify, and the like). As an example, consider a virtual machine running a web service (Service1), using IP address 10.0.2.1, and having some software that exhibits a security vulnerability. When security scan software detects a security vulnerability at IP 10.0.2.1 (the IP address of Service1), the cloud resource inventory has the IP address recorded, but may not have any associated product or service to tie to the IP address, which can result in attempts to mitigate being difficult. With the mapping provided according to some example implementations of the current subject matter, IP address can be referenced and the name of the specific service can be extracted, which can help directly identify the responsible team and/or person. In addition, if the vulnerability is associated with a particular request, the Time Stamp, TransactionID and Customer information fields can be used to identify additional details, which can be necessary to mitigate the security threat.

In addition to governance and security, the current subject matter can enable target test and staging environments to restrict deployment of items, which can reduce cost. Policies can be applied to limit the number of resources. In some implementations, resources can be shut down or removed from the system if they are part of a test environment and the resource is not active (e.g., there is no utilization of the resource). In some implementation, the current subject matter can enable enforcement of role based access control (RBAC) on cloud resources within the cloud environment.

The mapping between product or service and cloud resources can improve the management of those resources and products. For example, tracking service resources on a per product bases can enable effective utilization of cloud resources (e.g., in terms of their cost and usage). Determining the distribution of cost per product utilization and leveraging the mapped resources per service can aid in implementing cost effective solutions. For example, consider breaking down the cost of different features within a particular service. Consider a scenario in which one item in the log is the AbsoluteUru and a particular service supports a number of different endpoints (e.g., Uri) and are typically associated with features supported by the service. Using the mapping according to some example implementations enables the service utilization to be broken down by feature based on the number of logs to each Uri combined with the associated duration of each request. For example, consider 10 requests to a service:
3 ForestGet calls—duration 100 ms
3 DomainGet calls—duration 500 ms
3 UserGet calls—duration 3000 ms
1 AllUsersGet call—duration 3000 ms
   Considering a simple scenario, looking at number of calls shows an allocation of 30% ForestGet, 30% DomainGet, 30% UserGet and 10% AllUsersGet. Looking deeper at the duration shows a different allocation of 2% ForestGet, 8% DomainGet, 45% UserGet, 45% AllUsersGet. As is evident, additional data points can help to clarify a better understanding of the utilization of resources. Assessing the above reveals that many resources are consumed for the one AllUsersGet call. This insight can lead to modification or change to improve the system.

In some implementations, the mapping can enable getting cloud resource utilization metrics for a given product, which can enable upgrade or downgrade of the cloud resources, which can save cost per product.

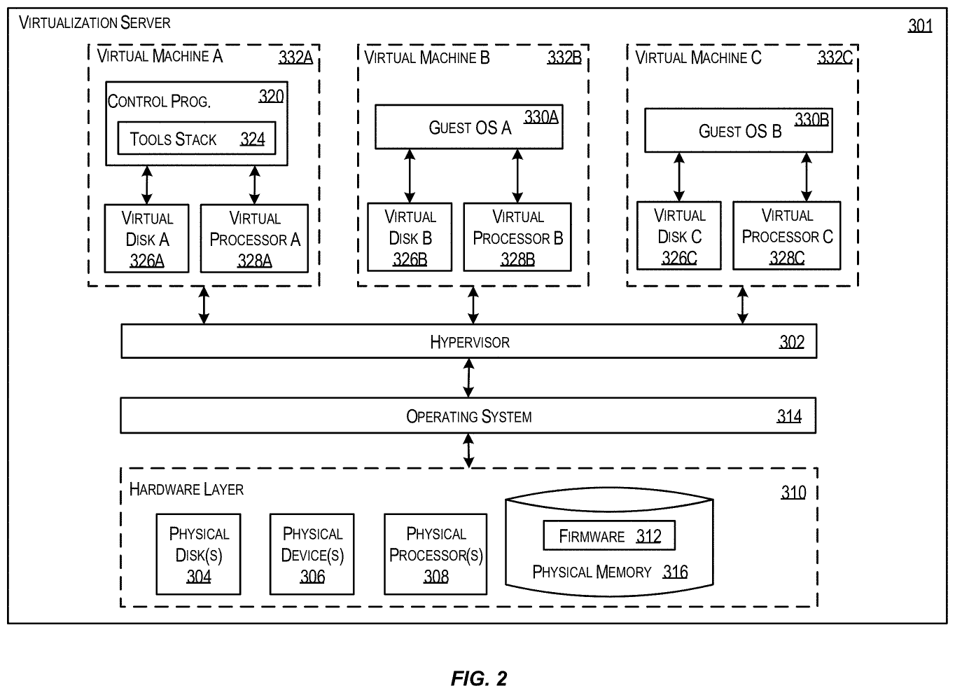

FIG. 2 shows a high-level architecture of an illustrative virtualization system for dynamic product resource mapping that can include dynamically grouping cloud resources according to product or service using a cloud resource inventory system and transaction logs that capture source and destination IP addresses. As shown, the virtualization system may be a single-server or multi-server system, or a cloud system, including at least one virtualization server 301 configured to provide virtual desktops and/or virtual applications to one or more client access devices 102a-c. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

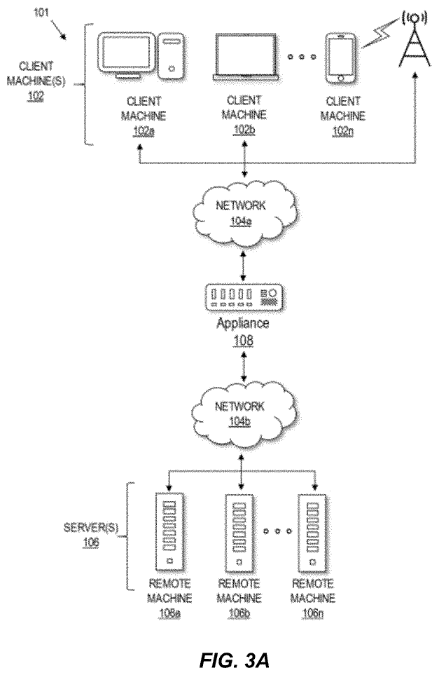

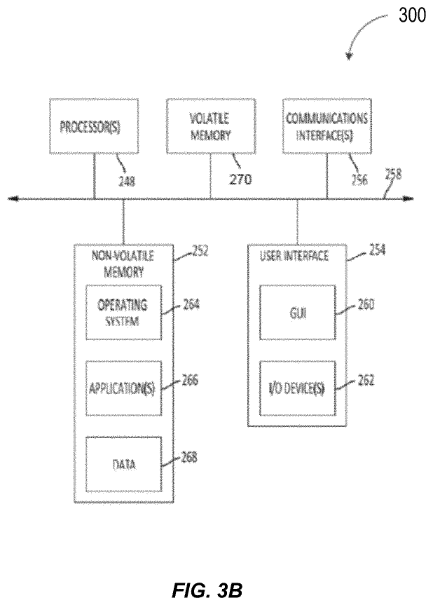

Virtualization server 301 may be configured as a virtualization server in a virtualization environment, for example, a single-server, multi-server, or cloud computing environment. Virtualization server 301 illustrated in FIG. 2 may be deployed as and/or implemented by one or more embodiments of server 106 illustrated in FIG. 3A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 2 illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 2, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 2 illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C(generally 326) and virtual processor 328A-C(generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disk 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

FIG. 3A depicts a network diagram illustrating an example of a network environment 101, that can enable dynamic product resource mapping that can include dynamically grouping cloud resources according to product or service using a cloud resource inventory system and transaction logs that capture source and destination IP addresses. Referring to FIG. 3A, the network environment 101 in which various aspects of the disclosure can be implemented can include one or more clients 102a-102n, one or more remote machines 106a-106n, one or more networks 104a and 104b, and one or more appliances 108 installed within the network environment 101. The clients 102a-102n communicate with the remote machines 106a-106n via the networks 104a and 104b.

The clients 102a-102n can communicate with the remote machines 106a-106n via an appliance 108. The illustrated appliance 108 is positioned between the networks 104a and 104b, and can also be referred to as a network interface or gateway. The appliance 108 can operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. Multiple appliances 108 can be used, and the appliance(s) 108 can be deployed as part of the network 104a and/or 104b.

The clients 102a-102n can be generally referred to as client machines, local machines, clients, client nodes, client computers, client devices, computing devices, endpoints, or endpoint nodes. The clients 102a-102n can include, for example, the first client 110a, the second client 110b, and/or the like. The remote machines 106a-106n can be generally referred to as servers or a server farm. The client 102 can have the capacity to function as both a client node seeking access to resources provided by a server 106 and as a server 106 providing access to hosted resources for other clients 102a-102n. The networks 104a and 104b can be generally referred to as a network 104. The network 104 including the networks 104a and 104b can be configured in any combination of wired and wireless networks.

The servers 106 can include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 can execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

The server 106 can execute a remote presentation services program or other program that uses a thin-client or a remote-display protocol to capture display output generated by an application executing on a server 106 and transmit the application display output to a client 102.

The server 106 can execute a virtual machine providing, to a user of a client 102, access to a computing environment. The client 102 can be a virtual machine. The virtual machine can be managed by, for example, a hypervisor, a virtual machine manager (VMM), or any other hardware virtualization technique within the server 106. The virtual machine can be deployed within a cloud provider.

The network 104 can be a local-area network (LAN), a metropolitan area network (MAN), a wide area network (WAN), a primary public network, and/or a primary private network. Additional embodiments can include one or more mobile telephone networks that use various protocols to communicate among mobile devices. For short-range communications within a wireless local-area network (WLAN), the protocols can include 802.11, Bluetooth, and Near Field Communication (NFC).

FIG. 3B depicts a block diagram illustrating an example of a computing device 300, in accordance with some example embodiments. Referring to FIGS. 3A-B, the computing device 300 can be useful for practicing an embodiment of the clients 102, the servers 106, and/or the appliances 108.

As shown in FIG. 3B, the computing device 300 can include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 can include a graphical user interface (GUI) 260 (e.g., a touchscreen, a display, and/or the like) and one or more input/output (I/O) devices 262 (e.g., a mouse, a keyboard, and/or the like). In some implementations, the one or more input/output devices 262 can include a front facing camera. The non-volatile memory 252 can store an operating system 264, one or more applications 266, and data 268 such that computer instructions of the operating system 264 and/or applications 266 are executed by the processor(s) 248 out of the volatile memory 270. Data can be entered using an input device of the GUI 260 or received from I/O device(s) 262. Various elements of the computing device 300 can communicate via communication the bus 258. The computing device 300 as shown in FIG. 3B is shown merely as an example, as the clients 102, the servers 106, and the appliances 108 can be implemented by any computing or processing environment and with any type of machine or set of machines that can have suitable hardware and/or software capable of operating as described herein.

The processor(s) 248 can be implemented by one or more programmable processors executing one or more computer programs to perform the functions of the system. As used herein, the term “processor” describes an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” can be analog, digital or mixed-signal. In some example embodiments, the “processor” can be one or more physical processors or one or more “virtual” (e.g., remotely located or “cloud”) processors.

The communications interfaces 256 can include one or more interfaces to enable the computing device 300 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 300 can execute an application on behalf of a user of a client computing device (e.g., the clients 102), can execute a virtual machine, which provides an execution session within which applications execute on behalf of a user or a client computing device (e.g., the clients 102), such as a hosted desktop session, can execute a terminal services session to provide a hosted desktop environment, or can provide access to a computing environment including one or more of: one or more applications, one or more desktop applications, and one or more desktop sessions in which one or more applications can execute.

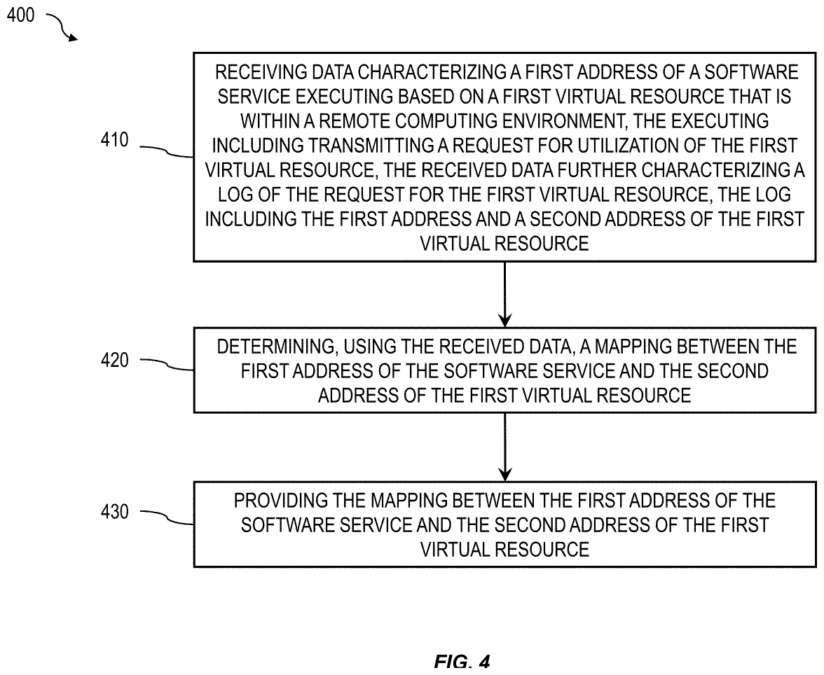

FIG. 4 is a process flow diagram illustrating another example process 400 that can enable dynamic product resource mapping that can include dynamically grouping cloud resources according to product or service using a cloud resource inventory system and transaction logs that capture source and destination IP addresses.

At 410, data is received characterizing a first address of a software service executing using a first virtual resource that is within a remote computing environment (e.g., a cloud provider). The executing can include transmitting a request for utilization of the first virtual resource, such as via an API call. The received data can further characterize a log of the request for the first virtual resource. The log can include the first address and a second address of the first virtual resource. The first address and the second address can be internet protocol addresses, although other types of addresses are possible.

In some implementations, the data characterizing the first address of the software service is received from a resource management inventory system including a database storing software service names and addresses. The data characterizing the log can be received from a repository associated with the software service and logging system transactions between the software service and the virtual resource.

The virtual resource can include a virtual machine, a storage account, a web application, a database, and/or a virtual network. Other types of virtual resources are possible.

At 420, a mapping between the first address of the software service and the second address of the first virtual resource can be determined using the received data. In some implementations, the mapping between the first address of the software service and the second address of the first virtual resource can include a data object containing a name of the software service, the first address, and data characterizing each virtual resource utilized by the software service.

At 430, the mapping between the first address of the software service and the second address of the first virtual resource can be provided. In some implementations, the mapping can be used for identifying virtual resources utilized by the software service that are within the remote computing environment. In some implementations, all virtual resources that are utilized by the software service can be identified. The mapping can be provided to a resource management inventory system including a database storing software service names and addresses.

In some implementations, the process (e.g., the receiving, the determining, and the providing) can be repeated using a new log. The process can be repeated regularly, such as periodically, or after a predetermined event, such as a change to a product or service.

In some implementations, the receiving includes receiving a plurality of addresses associated with respective software services and receiving a plurality of logs including a plurality of second addresses associated with respective virtual resources. The logs may include additional information, for example, as described above. The mapping can be between the plurality of software services and the plurality of virtual resources.

In some implementations, the software service includes at least one microservice, for example, a set of microservices. In some implementations, the software service is a microservice, which includes executable code.

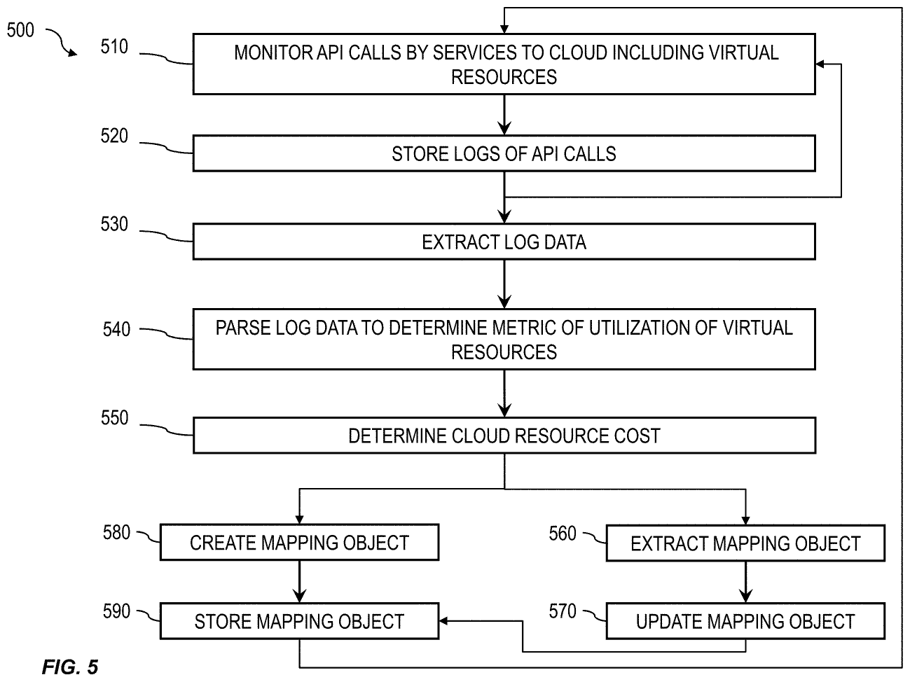

FIG. 5 is another process flow diagram illustrating an example process 500 that can enable dynamic product resource mapping that can include dynamically grouping cloud resources according to product or service using a cloud resource inventory system and transaction logs that capture source and destination IP addresses.

At 510, API calls by services to a cloud (e.g., remote computing environment) including virtual resources are monitored. The monitoring can include writing or creating a log entry every time a service performs an API call to the cloud. The log entry can include the source address, which includes the IP address of the service making the API call, and the destination address, which includes the IP address of the virtual resource that is utilized in performing the API call. Other information can be included in the log entry, such as a name of the service and/or product making the API call.

At 520, the log entries that are written and/or created during the monitoring of the API calls can be stored into a database. Once storage of the log entries is complete, the process 500 can return to monitoring the API calls at 510. Regularly (e.g., periodically) or at other times, the process can, at 530, extract the log data from the database. In some implementations, the log data that is extracted from the database can be a subset of all log data. The subset can be determined according to some criterion, such as being limited to those logs that were created or added to the database since the last time a mapping object was last updated.

At 540, the log data is parsed to identify the source and destination addresses for each API call. At 550, a mapping between service and resource can be determined. Determining the mapping can include determining, for each service IP address included in the log data, the associated resource IP address. The determining the mapping can include determining if there is an existing mapping object for a given service and if the identified resource is already included in the mapping object. If there exists a mapping object and the mapping object does not indicate that the given service utilizes the identified resource, then at 560, the mapping object can be extracted from a mapping object database and, at 570, the mapping object can be updated with the identified resource IP address. The updated mapping object can be stored at 590.

If there is no existing mapping object, then at 580, a new mapping object can be created. The new mapping object can associate the service with the identified resource. At 590, the new mapping object can be stored. The process 500 can then return to monitoring the API calls at 510. In some implementations, monitoring the API calls at 510 is performed continuously and/or in parallel with the rest of the process 500.

Some implementations of the current subject matter can provide for many technical advantages. For example, some implementations require no human intervention and no specific internal knowledge is required or used. Some implementations of this approach can be traceable and can be less prone to errors than a manual tagging approach. In addition, cloud providers have different limitations on the number of tags that can be applied to a cloud resource, and some cloud providers do not support tagging of cloud resources. With some implementations of the current approach, external dependency on the cloud provider capability is eliminated, which can maintain an uniform approach.

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A method comprising:
receiving data characterizing a first address of a software service executing based on a first virtual resource that is within a remote computing environment, the executing including transmitting a request for utilization of the first virtual resource, the received data further characterizing a log of the request for the first virtual resource, the log including the first address and a second address of the first virtual resource;
determining, using the received data, a mapping between the first address of the software service and the second address of the first virtual resource; and
providing the mapping between the first address of the software service and the second address of the first virtual resource.

2. The method of claim 1, further comprising:
identifying, based on the mapping between the first address of the software service and the second address of the first virtual resource, virtual resources utilized by the software service that are within the remote computing environment.

3. The method of claim 2, wherein all virtual resources utilized by the software service that are within the remote computing environment are identified.

4. The method of claim 1, wherein the mapping between the first address of the software service and the second address of the first virtual resource includes a data object containing a name of the software service, the first address, and data characterizing each virtual resource utilized by the software service.

5. The method of claim 1, wherein the receiving includes receiving a plurality of addresses associated with respective software services and receiving a plurality of logs including a plurality of second addresses associated with respective virtual resources, and wherein the mapping is between the plurality of software services and the plurality of virtual resources.

6. The method of claim 1, wherein the data characterizing the first address of the software service is received from a resource management inventory system including a database storing software service names and addresses.

7. The method of claim 1, wherein the data characterizing the log is received from a repository associated with the software service and logging system transactions between the software service and the virtual resource.

8. The method of claim 1, further comprising repeating the receiving, the determining, and the providing based on a new log.

9. The method of claim 1, wherein the virtual resource includes a virtual machine, a storage account, a web application, a database, and/or a virtual network.

10. The method of claim 1, wherein the mapping is provided to a resource management inventory system including a database storing software service names and addresses.

11. The method of claim 1, wherein the software service includes at least one microservice including executable code deployed in the remote computing environment.

12. A system comprising:
at least one data processor; and
memory storing instructions which, when executed by the at least one data processor, causes the at least one data processor to perform operations comprising:
receiving data characterizing a first address of a software service executing based on a first virtual resource that is within a remote computing environment, the executing including transmitting a request for utilization of the first virtual resource, the received data further characterizing a log of the request for the first virtual resource, the log including the first address and a second address of the first virtual resource;
determining, using the received data, a mapping between the first address of the software service and the second address of the first virtual resource; and
providing the mapping between the first address of the software service and the second address of the first virtual resource.

13. The system of claim 12, the operations further comprising:
identifying, based on the mapping between the first address of the software service and the second address of the first virtual resource, virtual resources utilized by the software service that are within the remote computing environment.

14. The system of claim 13, wherein all virtual resources utilized by the software service that are within the remote computing environment are identified.

15. The system of claim 12, wherein the mapping between the first address of the software service and the second address of the first virtual resource includes a data object containing a name of the software service, the first address, and data characterizing each virtual resource utilized by the software service.

16. The system of claim 12, wherein the receiving includes receiving a plurality of addresses associated with respective software services and receiving a plurality of logs including a plurality of second addresses associated with respective virtual resources, and wherein the mapping is between the plurality of software services and the plurality of virtual resources.

17. The system of claim 12, wherein the data characterizing the first address of the software service is received from a resource management inventory system including a database storing software service names and addresses.

18. The system of claim 12, wherein the data characterizing the log is received from a repository associated with the software service and logging system transactions between the software service and the virtual resource.

19. The system of claim 12, the operations further comprising repeating the receiving, the determining, and the providing based on a new log.

20. A non-transitory computer readable medium storing instructions which, when executed by at least one data processor forming part of at least one computing system, causes the at least one data processor to perform operations comprising:
receiving data characterizing a first address of a software service executing based on a first virtual resource that is within a remote computing environment, the executing including transmitting a request for utilization of the first virtual resource, the received data further characterizing a log of the request for the first virtual resource, the log including the first address and a second address of the first virtual resource;
determining, using the received data, a mapping between the first address of the software service and the second address of the first virtual resource; and
providing the mapping between the first address of the software service and the second address of the first virtual resource.
